(19) United States
(12) Patent Application Publication
(10) Pub. No.: US 2011/0258231 A1
(43) Pub. Date: Oct. 20, 2011

(54) Method and Apparatus for Providing the Information of Adverse Drug Effects

(75) Inventors: Feng Cao, ShangHai (CN); Gang Hu, Beijing (CN); Jing Li, Beijing (CN); Yue Pan, Beijing (CN); Wang Xiaoyuan, Shanghai (CN); Xing Zhi sun, Beijing (CN)

(73) Assignee: INTERNATIONAL BUSINESS MACHINES CORPORATION, Armonk, NY (US)

(21) Appl. No.: 13/075,396

(22) Filed: Mar. 30, 2011

(30) Foreign Application Priority Data
Mar. 31, 2010 (CN) 201010138982.2

(51) Int. Cl. G06F 17/30; G06N 5/02; G06N 7/02

(52) U.S. Cl. 707/780; 707/E17.014

(57) ABSTRACT

A method and apparatus for providing the information of adverse drug effects. The method includes: extracting at least a first information and a second information in basic information of a drug from a drug information source; matching the drug with a particular drug-related concept in a structured and normalized terminology system according to the first and the second information; extracting, from the drug information source, the information of Adverse Drug Effects associated with the drug; and matching the information of Adverse Drug Effects with a particular disorder-related concept in the structured and normalized terminology system; wherein the matching is along different paths in at least two disorder-related classified hierarchies. The invention can extract, standardize, and normalize information relating to adverse drug effects to help the integration, search, calculation, and propagation thereof.

### CROSS-REFERENCE TO RELATED APPLICATION

This application claims priority under 35 U.S.C. §119 from Chinese Patent Application No. 201010138982.2, filed Mar. 31, 2010, the entire contents of which are incorporated herein by reference.

### BACKGROUND OF THE INVENTION

The present invention relates to the collection and provision of pharmaceutical information, and more particularly, to a method and apparatus for providing the information concerning adverse drug effects.

An Adverse Drug Reaction (ADR) is a response to a drug which is noxious and unintended and which occurs at doses normally used for prophylaxis, diagnosis, or therapy of diseases, or for the modification of physiologic function. An Adverse Drug Event (ADE) is an adverse clinical event which occurs during the use of drugs, and usually the causal link between the drug use and the event is indeterminate. ADR and ADE can be resulted from a side effect (side reaction) or a toxic effect of a drug, or a drug-drug interaction.

For the sake of convenience, we will refer to the adverse symptoms such as ADR, ADE, etc. as Adverse Drug Effects (ADR/E) hereinafter. With the dramatic increase of the species of drugs, the Adverse Drug Effects are becoming more and more harmful to public health. Statistics show that ADE is one of the leading causes of death, ahead of lung disease, diabetes, AIDS, and automobile traffic accidents. ADE/ADR cause 1 out of 5 injuries or deaths per year to hospitalized patients. In China, reports of ADE/ADR cases reached at least 170,000 in 2005. In the United States, over 2 million serious ADEs occur yearly, causing 100,000 deaths.

This severe problem is a result of the inadequacy in the acquaintance and utilization of the information of Adverse Drug Effects. On the one hand, the information of Adverse Drug Effects are mainly described on drug labels, instructions, or research materials in pharmaceutical institutions, thus making it difficult to query comprehensively. Although some institutions are already involved in collecting drug information, the information thus provided has many problems in the use of systematic query. This is because, in the pharmaceutical industry, expression differences often exist. For example, one drug usually has different trade names and medical names, and one clinical symptom can have different descriptive languages; this descriptive inconsistency brings many difficulties to the provision and query of the ADE/ADR information. For example, the terms heart attack, myocardial infarction, and MI can refer to the same thing to a cardiologist, but, to a computer, they are all different. Therefore, currently, it is time-consumptive for a doctor to check the ADE/ADR information systematically and accurately.

Under these circumstances, the doctor has to prescribe for a patient based on his/her practical knowledge on drugs without checking the ADE/ADR information. Furthermore, the doctor has no idea of what other doctors prescribed for the patient, or the detailed physical quality of the patient, and therefore, the doctor has to recommend drugs according to the general symptoms without considering the individual condition of the patient.

In addition, the inconsistency in describing the ADE/ADR information by various information sources and various institutions makes it difficult to combine and process the information provided by different institutions. As such, drug-related institutions cannot obtain and utilize effectively the ADE/ADR information, and thus cannot apply this information to the drug-related research.

Therefore, a system is needed, which can automatically collect the information concerning the Adverse Drug Effects, and make it standardized and normalized, in order to facilitate the provision and update of the Adverse Drug Effects information by drug-related institutions and to expedite the query conducted by doctors and related personnel.

### SUMMARY OF THE INVENTION

The present invention was made in view of the problems and disadvantages set forth above. The invention is proposed so as to provide a method and apparatus for providing the information of Adverse Drug Effects, which can provide comprehensively the normalized information of Adverse Drug Effects, thus overcoming the defects of the prior art.

Accordingly, one aspect of the present invention provides a method for providing information of adverse drug effects including: extracting at least a first information and a second information in basic information of a drug from a drug information source; matching the drug with a particular drug-related concept in a structured and normalized terminology system according to the first and the second information; extracting, from the drug information source, the information of Adverse Drug Effects associated with the drug; and matching the information of Adverse Drug Effects with a particular disorder-related concept in the structured and normalized terminology system; wherein the matching is along different paths in at least two disorder-related classified hierarchies.

Another aspect of the present invention provides an apparatus for providing information of Adverse Drug Effects of a drug including: a drug information extracting unit configured to extract at least a first information and a second information in basic information of a drug from a drug information source; a drug information matching unit configured to match the drug with a particular drug-related concept in a structured and normalized terminology system according to the first and the second information; an adverse effects information extracting unit, configured to extract from the drug information source the information of Adverse Drug Effects; and an adverse effects information matching unit, configured to match the information of Adverse Drug Effects with a particular disorder-related concept in the structured and normalized terminology system, wherein the matching is along different paths in at least two disorder-related classified hierarchies.

By using the method and apparatus of the invention, one can comprehensively extract the information concerning Adverse Drug Effects, and make it standardized and normalized, so as to facilitate the collection, integration, search, calculation, and propagation of the information, and thereby bring convenience to medicine-related organizations and individuals.

### BRIEF DESCRIPTION OF THE DRAWINGS

FIG. 1 is a flow chart showing a method for providing the information of Adverse Drug Effects according to an example of the invention;

FIG. 2 shows the detailed implementation of step 102 in FIG. 1;

FIG. 3A-3C show explanations and descriptions to several exemplary concepts in SNOMED CT system;

FIG. 4 shows an example of a labeled content of a section;

FIG. 5 exemplarily shows a part of concepts in SNOMED CT system relating to the term for adverse effects “nausea”;

FIG. 6 shows another example of a labeled content of a section;

FIG. 7 exemplarily shows the matching process of the term for adverse effects “nausea”; and

FIG. 8 shows an apparatus for providing the information of Adverse Drug Effects according to an example of the invention.

### DETAILED DESCRIPTION OF THE PREFERRED EMBODIMENT

Next, detailed embodiments of the invention will be described in conjunction with detailed examples. It should be appreciated that the description of the following detailed embodiments are merely to explain the invention, rather than to impose any limitation on scope of the invention.

As described above, the present invention proposes a method and system which can automatically and comprehensively provide the information of Adverse Drug Effects in a standardized and normalized way. However, providing such a system faces challenges of several aspects. The first problem is with respect to the information sources of drugs. As drugs are present in a great variety and a large number, and change frequently, the information sources are supposed to be comprehensive, accurate, and updated. In addition, it is desired that the information sources are organized in a structured or semi-structured way so as to facilitate the extraction and analysis of the information. Another problem is with respect to term unification, which is very important in the standardization and normalization of the information of Adverse Drug Effects. To this end, it is necessary to refer to the standard terminology system that is commonly used in the industry, and it is also desired that the system is organized in a hierarchy form, in order to indicate the classification and subordination relationship between various terms.

As to the selection of the information sources of drugs, the most easily accessible and accurate information sources are drug labels. Drug labels include a comprehensive, concise and accurate description to the characteristics, efficacy and safety of drugs. Usually, drug labels have the following main content: chief description, clinical pharmacology, route of administration and dosage, contraindication, warning information, etc. In order to collect the information on drug labels, a structured pharmaceutical/product labeling (SPL) system has been developed to promote the summarizing and publishing of drug information. SPL was initially developed by HL7 (Health Level Seven) in the U.S., and then was adopted by the U.S. Food and Drug Administration (FDA) as a standard system for exchanging drug information. The FDA requires all drug companies which produce prescription drugs, OTC drugs, biological drugs or animal medicine to register and submit all drug labels in SPL standard format.

Particularly, according to SPL, the contents in drug labels are defined in XML format, and displayed in a web browser. A SPL file includes the contents in a drug label (all the texts, tables and pictures) as well as additional machine-readable information. Usually, SPL includes in its first level (level-1) structure the description relating to the basic information of a drug, such as the drug name, the active ingredient, the dosage form, the appearance, etc. Furthermore, as a structured file, SPL includes in its second level (level-2) a section relating to the Adverse Drug Effects, which section generally includes a start tag such as “adverse reaction” or “warning”. The SPL for some drugs also includes in its third level (level-3) more detailed information relating to the Adverse Drug Effects. Therefore, it can be seen that the SPL structured files, which are adopted by the FDA as authoritative and accurate drug information, are very suitable to be the information sources for extracting the information of Adverse Drug Effects. However, it can be understood that the drug information of other sources can be used as information sources, such as the summary reports on drug information made in other countries or by other institutions (for example, an institution of studying and analyzing drugs).

As to the selection of the standard terminology system, SNOMED CT (Systematized Nomenclature of Medicine—Clinical Terms) is a terminology system which is currently widely used. SNOMED CT is a systematically organized computer processable collection of medical terminology covering most areas of clinical information such as diseases, findings, procedures, microorganisms, pharmaceuticals etc. It allows a consistent way to index, store, retrieve, and aggregate clinical data across specialties and sites of care. It also helps organizing the content of medical records, reducing the variability in the way data is captured, encoded and used for clinical care of patients and research.

Particularly, SNOMED CT is a thesaurus of more than 365,000 clinical concepts, and each concept is defined by a unique numeric code, a unique name (Fully Specified Name) and a “description”. It contains more than 993,420 descriptions or synonyms for flexibility in expressing clinical concepts. These concepts are organized into 19 upper level hierarchies, including the hierarchy for medical procedure-related concepts, the hierarchy for drug-related concepts, the hierarchy for clinical disorder-related concepts, and the like. Each upper level hierarchy has several classified children hierarchies, for example, the drug-related concepts can be classified based on the drug name, the dosage form, etc, thus obtaining the further classified hierarchies; the clinical disorder-related concepts can be classified based on the body sites, the causes (induced by drugs), etc, thus obtaining the further classified hierarchies. The different concepts within a hierarchy or across hierarchies are linked by using about 1,460,000 “relationships.” Thus, SNOMED CT forms a compositional concept system on the basis of description logic. As SNOMED CT has characteristics set forth above, it is preferred to take it as the standard terminology system to standardize the description of drug ADE/ADR information. However, it can be understood that the terminology system is not limited to SNOMED CT, and any normalized and structured terminology system, which has been already developed or will be developed in future, can be used, such as MedDRA terminology system.

For the purpose of detailed description, the embodiments of the invention will be described in conjunction with exemplary SPL information sources and SNOMED CT terminology system.

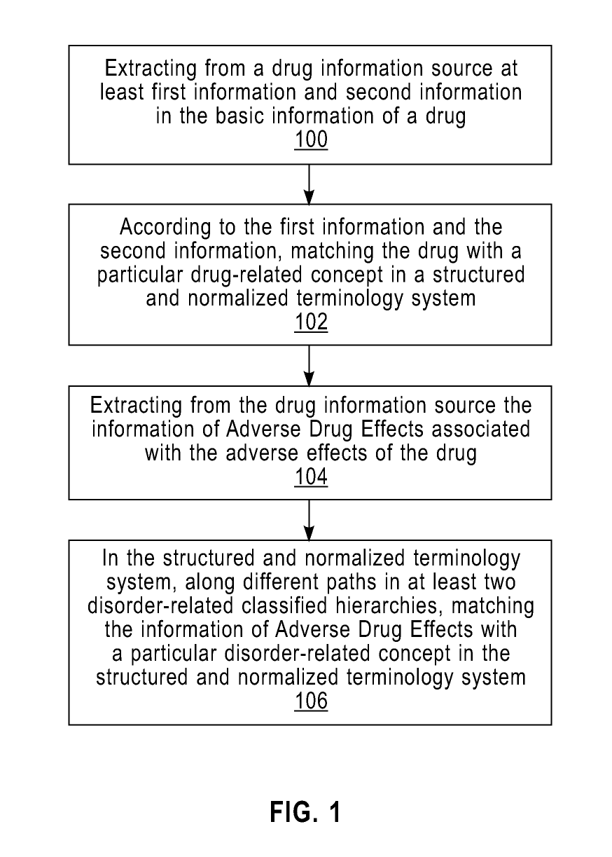

FIG. 1 is a flow chart showing a method for providing the information of Adverse Drug Effects according to an example of the invention. The method includes step 100, extracting from a drug information source at least first information and second information in the basic information of a drug; step 102, according to the first information and the second information, matching the drug with a particular drug-related concept in a structured and normalized terminology system; step 104, extracting from the drug information source the information of Adverse Drug Effects associated with the adverse effects of the drug; and step 106, in the structured and normalized terminology system, along different paths in at least two disorder-related classified hierarchies, matching the information of Adverse Drug Effects with a particular disorder-related concept in the structured and normalized terminology system. In particular, in an example, the drug information source is SPL files, and the structured and normalized terminology system is SNOMED CT system. Next, the implementation of the steps of the method according to the invention will be illustrated in conjunction with an exemplary SPL code.

The exemplary SPL code:

<structuredBody>
<component>
<section>
<id root=“FC6AB7C2-7000-C666-C960-E0D4F0941D15” />
<effectiveTime value=“20070713” />
<subject>
<manufacturedProduct>
<manufacturedMedicine>
<code code=“0703-4852” codeSystem=“2.16.840.1.113883.6.69” />
<name>Fludarabine Phosphate</name>
<formCode code=“C42946” codeSystem=“2.16.840.1.113883.3.26.1.1”

displayName=“INJECTION” />

<activeIngredient>
<activeIngredientSubstance>
<code code=“1X9VK9O1SC” codeSystem=“2.16.840.1.113883.4.9”

codeSystemName=“FDA SRS” />

<name>Fludarabine Phosphate</name>
<activeMoiety>
<code code=“P2K93U8740” codeSystem=“2.16.840.1.113883.4.9”

codeSystemName=“FDA SRS” />

<name>Fludarabine</name>
</activeMoiety>
</activeIngredientSubstance>
</activeIngredient>
<asEntityWithGeneric>
<genericMedicine>
<name>Fludarabine Phosphate</name>
</genericMedicine>
</asEntityWithGeneric>
</manufacturedMedicine>
</manufacturedProduct>
</section>
</component>
<component>
<section ID=“INV-ed45a274-bc66-49aa-a984-aeba48c68794”>
<id root=“85AF0A6E-CEBF-2A47-EF0E-1727791D6884” />
<code code=“34084-4” codeSystem=“2.16.840.1.113883.6.1”

codeSystemName=“LOINC” displayName=“ADVERSE REACTIONS SECTION” />

<title ID=“INV-84e6de86-4a70-45ab-85ab-692002a994df”

mediaType=“text/x-hl7-title+xml”>ADVERSE REACTIONS</title>

<text ID=“INV-43ea933a-ab44-4a8a-86de-300e1e031520”><paragraph

ID=“INV-330f9415-81ca-4f1d-91e3-79a46a39efcb”>The most common adverse events
include myelosuppression (neutropenia, thrombocytopenia and anemia), fever and chills,
infection, and nausea and vomiting. Other commonly reported events include malaise,
fatigue, anorexia, and weakness. Serious opportunistic infections have occurred in CLL
patients treated with fludarabine. The most frequently reported adverse events and
those reactions which are more clearly related to the drug are arranged below according
to body system.</paragraph>

<paragraph ID=“INV-666153d9-10aa-403f-9e40-83fafd20f80a”><content

styleCode=“bold”>Nervous System</content></paragraph><paragraph
ID=“INV-80101f38-73fc-4cc4-9e9a-25765b79cb22”>(See <content
styleCode=“bold”>WARNINGS</content> section)</paragraph><paragraph
ID=“INV-44502039-af84-4f15-be6f-158d16210dcd”>Objective weakness, agitation,
confusion, visual disturbances, and coma have occurred in CLL patients treated with
fludarabine at the recommended dose. Peripheral neuropathy has been observed in
patients treated with fludarabine and one case of wrist-drop was reported.</paragraph>

</section>
</component>
</structuredBody>

The above code contains the structured definitions and descriptions to pieces of information involved in a drug label, wherein the first half is a description to the basic information of the drug. The basic information substantially includes the main features of the drug, such as drug name, dosage form, ingredients, etc. Pieces of basic information of the drug that the code is directed to can be obtained by recognizing tags in the code. For example, by recognizing the code “<manufacturedMedicine> . . . <name>Fludarabine Phosphate </name>, it can be known that the manufactured medicine name of the drug is Fludarabine Phosphate; by recognizing the code “formCode code=“C42946””, which stands for “dosage form” in the SPL system, and recognizing that the tag value is Injection (“displayName=“INJECTION”), it can be known that the dosage form of the drug is injection. Similarly, at least the following information can be obtained from the above code:

Manufactured medicine name: Fludarabine Phosphate;

Generic drug name: Fludarabine Phosphate;

Dosage form: Injection;

Active ingredient substance: Fludarabine Phosphate;

Active moiety: Fludarabine.

The examples of the basic information are not limited to the information enumerated above. In other examples, the basic information can comprise different or additional pieces of information, such as drug property, chemical name, etc. From the basic information extracted, at least two pieces of the basic information can be selected for subsequent use in matching the drug into the standard terminology system, wherein the selected two pieces of the basic information cross with each other in two corresponding classified hierarchies relating to drugs. In one example, generic drug name is selected as the first information (Generic drug name: Fludarabine Phosphate), and dosage form is selected as the second information (Dosage form: Injection). By using the selected first information and second information, the drug can be matched with a particular drug-related concept in SNOMED CT. In particular, firstly, the first information is used to carry out preliminary matching, thus obtaining at least one candidate concept; then, the second information is used to carry out further matching for the at least one candidate concept, thus obtaining the matched particular concept.

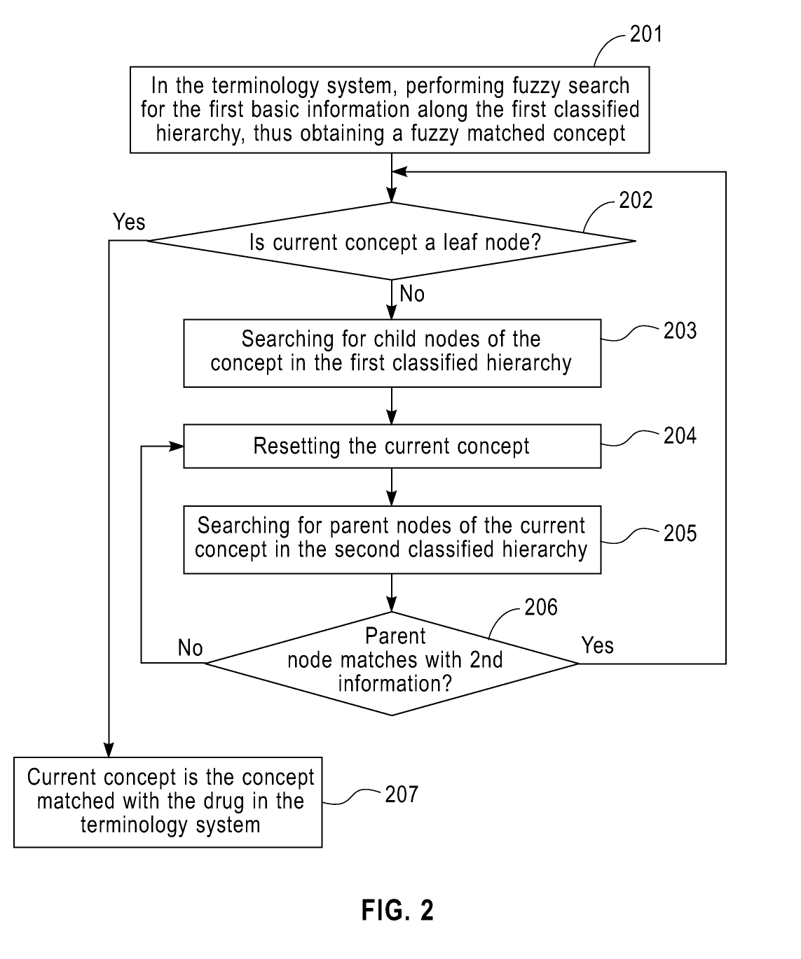

FIG. 2 shows the detailed implementation of step 102 in FIG. 1. As shown in FIG. 2, step 201 is, among drug-related concepts in the structured terminology system, performing fuzzy search for the first basic information along the first classified hierarchy, thus obtaining a fuzzy matched concept, wherein the first classified hierarchy is a hierarchy in which the drug-related concepts are classified based on the first information. Generally, this step combines tree search conducted along the first classified hierarchy with literal search for the first information itself, and stops when it reaches a concept fuzzy matching with the first information along a certain path in the first classified hierarchy. The candidate concept thus obtained is generally a relatively generic concept. In the example as shown in the above code, the first basic information is generic drug name—Fludarabine Phosphate, and thus the first classified hierarchy is a hierarchy in which the drug-related concepts are classified based on drug names. Beginning from “pharmaceutical”—the root node of the first classified hierarchy, path search is conducted from top to bottom along the tree hierarchy until the fuzzy match with the drug name Fludarabine Phosphate is achieved. In this example, the path taken to achieve the fuzzy match is: Pharmaceutical->biologic product (product)->Antineoplastic agent (product)->Antimetabolite (product)->Purine analog (product)->Fludarabine (product). The above path reaches a concept “Fludarabine”, which is already partially matched with the drug name literally. Since the search is conducted from top to bottom, the concept thus obtained can be deemed to be a more generic concept than the actual drug name—Fludarabine Phosphate. In very rare conditions, the first information alone is sufficient to obtain the exactly matched concept in the standard terminology system. If so, the matching of the drug-related concepts can be conducted by using only the first information, or additionally, can be verified by using the second information. In most cases, the second information is needed to further judge and select the preliminarily matched concept.

Hence, step 202 is to judge whether the current concept obtained is a leaf node in the first classified hierarchy. If it is, the method jumps to step 207, in which the current concept is considered as the concept matched with the drug in the structured and normalized terminology system. If the current concept is not a leaf node, but has one or more child nodes, the method advances to step 203 to search for child nodes of the concept in the first classified hierarchy. In step 204, the child nodes thus found are in turn set as the current concept. For each child node set as the current concept, in step 205, the method searches for parent nodes of the child node (i.e. the current concept) in the second classified hierarchy, wherein the second classified hierarchy is a hierarchy in which the drug-related concepts are classified based on the second information. Then in step 206, the method judges whether the parent node described above matches with the second basic information of the drug; if it does not, it can be deemed that the corresponding child node is not the desired concept, and the method goes back to step 204 to set the next child node as the current concept and continue the judgment. If the result of judgment in step 206 is “matching”, the concept of this child node is considered as the selected concept. Then, the method goes back to step 202 to continue judging whether the selected concept is a leaf node; the method continues until the selected concept is a leaf node and at the same matches with the second information.

If the procedure described above fails to locate a particular concept based on the first information and the second information, the probable reason can be that the classified hierarchies corresponding to the selected first information and second information do not cross with each other. In this case, the first information and the second information can be reselected or changed, and the above procedure can be conducted once again and does not stop until a particular concept is located.

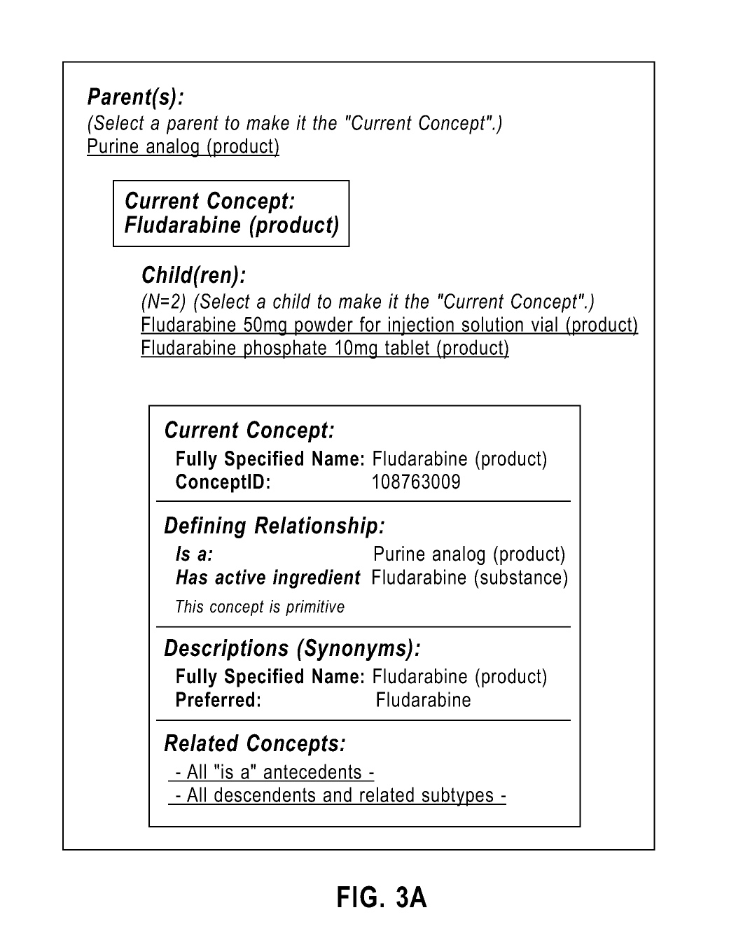

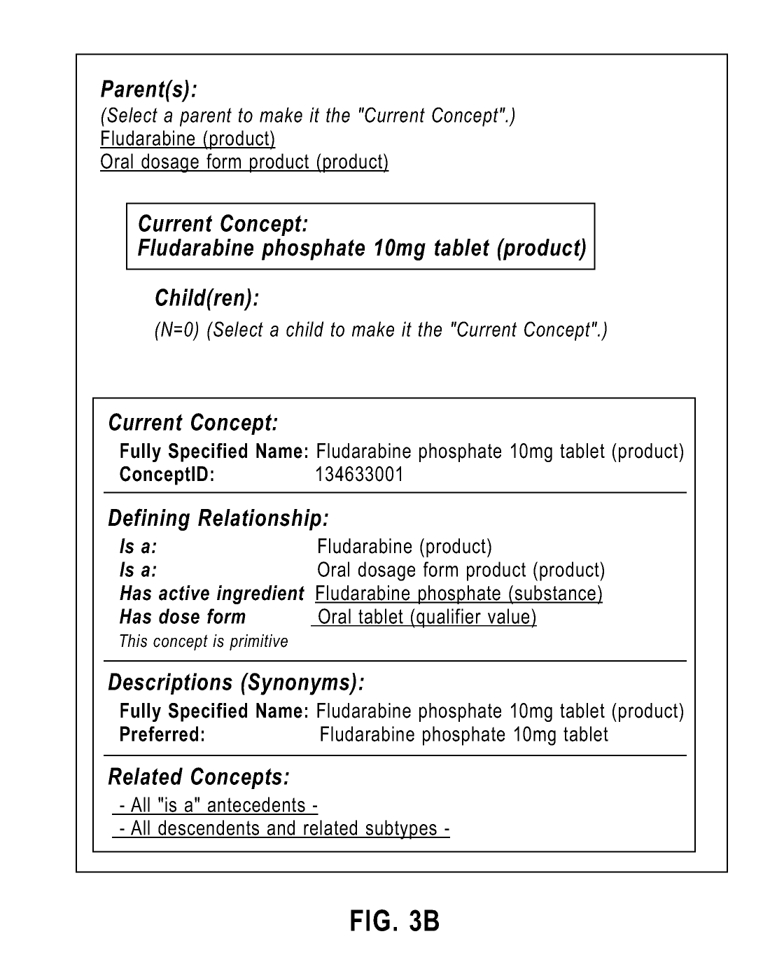

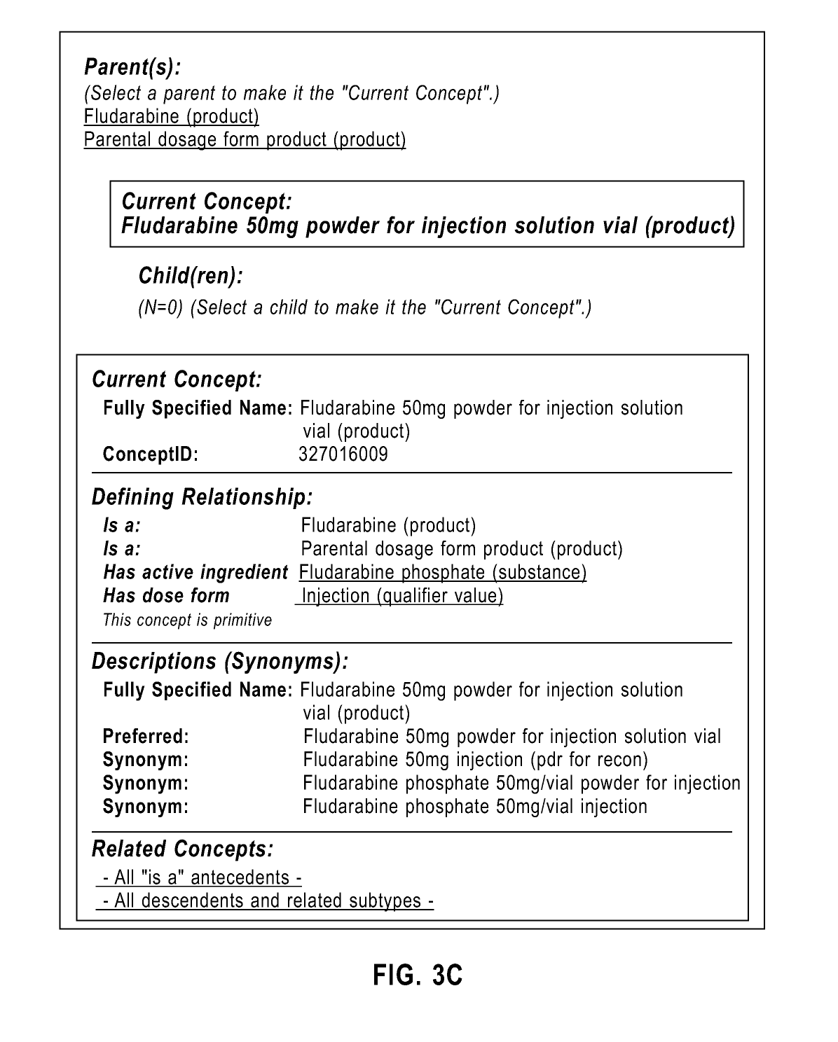

Now the above procedure will be described in combination with a given example. In step 201, the concept “Fludarabine” has been found as the result of fuzzy matching with the drug “Fludarabine Phosphate”, wherein the concept “Fludarabine” is explained and described in SNOMED CT as shown in FIG. 3A. As shown in FIG. 3A, the current concept is Fludarabine, its parent node is Purine analog (product), and its child nodes include the first child node—Fludarabine phosphate 10 mg tablet (product) and the second child node—Fludarabine 50 mg powder for injection solution vial (product). Therefore, from the above information, in step 202, judgment can be made that the current concept is not a leaf node; then, in step 203, the first child node and the second child node described above can be found by searching. In step 204, firstly, the first child node is set as the current concept. At this time, the explanation and description to the current concept is shown in FIG. 3B.

In particular, FIG. 3B shows that the current concept is Fludarabine phosphate 10 mg tablet (product), its parent nodes are Fludarabine (product) and Oral dosage form product (product), and it has no child nodes. Next in step 205, search is conducted for the parent node of the current child node in the second classified hierarchy. Of the two parent nodes shown in FIG. 3B, Fludarabine (product) is obviously a parent node in the first classified hierarchy, for it is the very node from which the current child node is derived in step 203. Therefore, it can be determined that Oral dosage form product (product) is the parent node of the current node in the second classified hierarchy. Next in step 206, judgment is made whether the above parent node matches with the second basic information of the drug, that is, to judge whether Oral dosage form product (product) matches with the second information “Dosage form: Injection”. In one particular example, “Injection” can be set as a key word of the second information, and a list of words can be defined to list the words having the same or similar meaning as the key word. The judgment of matching is carried out by determining whether the content to be judged falls within the list of words. A person skilled in the art can also employ other methods for the judgment of matching. In the above example, obviously, the information contained in the parent node does not match with the second information. Thus, the process goes back to step 204 to set the second child node as the current concept.

At this time, the description to the current concept is shown in FIG. 3C, that is, the current concept is Fludarabine 50 mg powder for injection solution vial (product), its parent nodes are Fludarabine (product) and Parenteral dosage form product (product), and it has no child nodes. In step 205, it can be determined that the parent node of the current concept in the second classified hierarchy is Parenteral dosage form product (product). In step 206, this parent node is compared with the second information. Since “parenteral” and “injection” mean the same thing in terms of dosage form, it can be deemed that this parent node matches with the second information, and the current concept can be set as the selected concept. Hence, the process goes back to step 202 to judge whether the current concept is a leaf node. As the selected concept has no child nodes as shown in FIG. 3C, in step 207, the selected concept Fludarabine 50 mg powder for injection solution vial (product) is considered as the concept matching with the drug Fludarabine Phosphate in SNOMED CT system.

In an alternative embodiment, after a child node is obtained as the current concept in step 205, a person skilled in the art can extract directly from the description to the current concept the description relating to the second information, and judge whether the description matches with the second information. For example, in the descriptions to the first child node “Fludarabine phosphate 10 mg tablet (product)” as shown in FIG. 3B, the description relating to dosage form can be extracted from the right side of FIG. 3B, that is, “has dose form: oral tablet (qualifier value)”. This description does not match with the second information “Dosage form: Injection”. While in the descriptions to the second child node “Fludarabine 50 mg powder for injection solution vial (product)” as shown in FIG. 3C, it can be seen that the description relating to dosage form is “has dose form: injection (qualifier value)”, which matches with the second information. Therefore, the first child node is discarded, and the second child node is retained for further analysis; the process continues until the obtained node is a leaf node.

The particular concepts exemplified above are only for exemplary purpose. In cases that the current concept is not a leaf node, the process can recursively carry out the steps of searching for child nodes and analyzing the child nodes by using the second information until the finally obtained concept is a leaf node and matches with the second information. The above implementation mode performs preliminary matching from top to bottom in the first classified hierarchy by using the first information as chief information, thus obtaining a generic concept; then screens and selects the successor nodes of the generic concept by using the second information, thus obtaining the matched specific concept. By combining the first information with the second information, accuracy can be guaranteed for matching drugs with concepts in SNOMED CT system. Additionally, the above process does not stop until the obtained concept is a leaf node, which ensures the accuracy and enough fineness when matching drugs with concepts.

Furthermore, although the above example selects the generic drug name as the first information, and the dosage form as the second information, the selection of the first information and the second information is not limited thereto. Other items in the basic information of drugs can be selected for use in matching drugs with concepts. For example, in one embodiment, the active ingredients and the dosage form of drugs can be selected as the first and second information, or the chemical names and properties of drugs can be selected as the first and second information. It should be understood that any two pieces of basic information of drugs, as long as they have corresponding hierarchies and explanations respectively in a structured terminology system and the two hierarchies cross with each other, can be selected for use in matching drugs with specific concepts in the terminology system. Additionally, the method can select more than two pieces of information, which can include the third information, the fourth information, and the like, in order to serve as a reference for further refining the concept or to verify the accuracy of the matched concept.

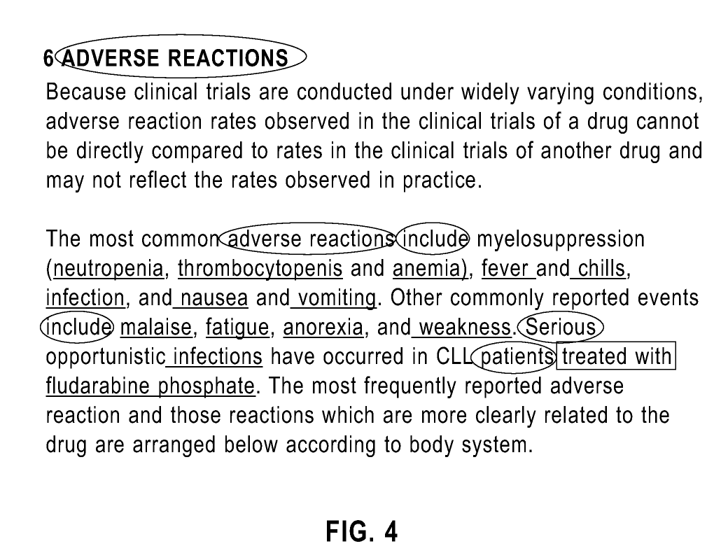

After obtaining the concept matched with the drug in the structured terminology system, the method advances to process the information of Adverse Drug Effects associated with the drug. First, it needs to extract from the drug information source the information of Adverse Drug Effects associated with the adverse effects of the drug, that is, to perform step 104 in FIG. 1. For an information source of SPL files, the drug ADE/ADR information is generally included in the level-2 and level-3 structures of SPL. More particularly, SPL generally includes in its level-2 structure the following sections: section of drug-drug interaction, section of adverse effects, section of contraindication, section of food security warning, section of environment warming, section of special group usage, section of warning and prevention, and the like. Sometimes, SPL further includes in its level-3 structure finer grained sections relating to ADE/ADR, such as conditions of usage, restrictions of usage, side effects, and the like. The above-mentioned sections are marked with corresponding tag symbols in the SPL source code (for example, the code “code=“34084-4””, as well as the tag symbol defining the title of the section present in the above SPL sample: <title ID=“INV-84e6de86-4a70-45ab-85ab-692002a994df” mediaType=“text/x-hl7-title+xml”>ADVERSE REACTIONS</title>, wherein the content of the section corresponds to FIG. 4), and therefore it is easy to locate and read the contents of these sections by recognizing such tag symbols. However, the content of a section thus obtained is generally a large block of text, and cannot be directly processed by computers in a standardized manner. Hence, it needs to extract from the contents of these sections the terms directly relating to Adverse Drug Effects.

In order to perform the extraction mentioned above, in one embodiment, the content of a section is labeled with three tokens, including terms for adverse effects, related key words, and clinical conditions. The labeling of the contents of sections can be realized by defining a list of probable related key words (for example, including adverse action, adverse event, include, occur, report, and the like), and considering the grammar of the language. Many well-established algorithms are already present in the prior art for the labeling and extraction of such key information.

FIG. 4 shows an example of a labeled content of a section. In particular, FIG. 4 shows the content of a section corresponding to the exemplary code in which adverse effects are described. In FIG. 4, terms of adverse effects are labeled with underlines, related key words with ellipses, and clinical status and conditions with rectangles.

Subsequently, the method goes on to analyze terms for adverse effects which directly describe the symptoms of adverse effects, in order to match them precisely with the corresponding concepts in the structured and normalized terminology system. This matching process will be illustrated by taking the term for adverse effects “nausea” for example as shown in FIG. 4.

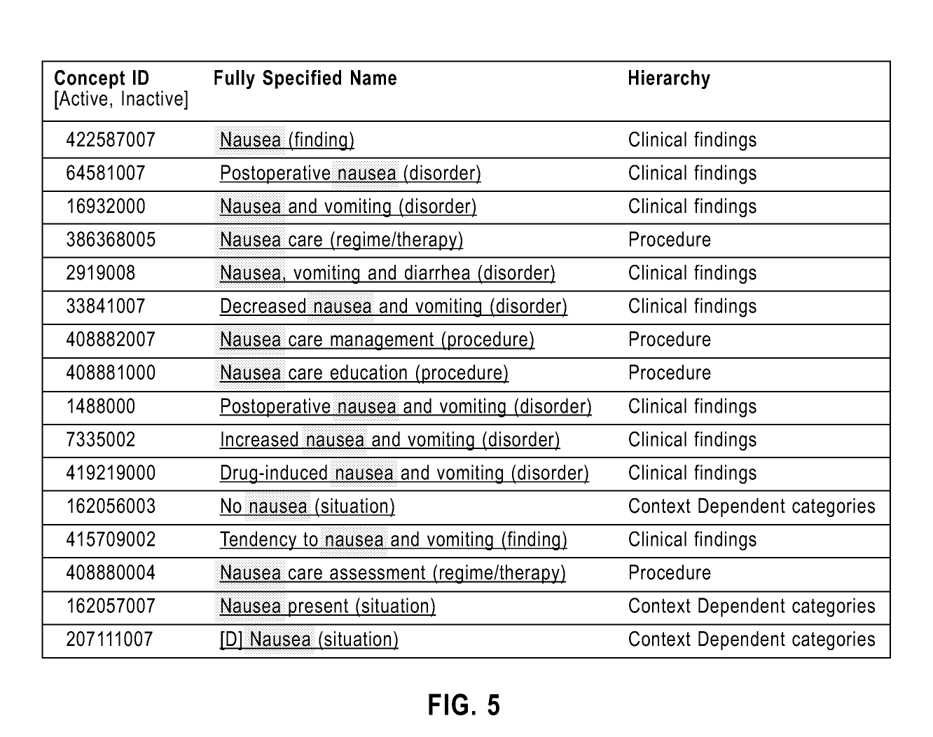

If we simply search for nausea in the SNOMED CT system, we will find many fuzzy matched concepts, as shown in FIG. 5. FIG. 5 exemplarily shows a part of concepts in SNOMED CT system relating to the term for adverse effects “nausea”. These concepts relate to different types and lie at different levels in a hierarchy, but they all comprise the term “nausea”. Now the problem is how to find, among these concepts, the most appropriate concept which is matched with the term.

According to one example of the invention, the combination of two paths is employed to find the most appropriate concept. In one embodiment, the first path is a path in the hierarchy in which disorder-related concepts are classified based on body sites, and the second path is a path in the hierarchy in which disorder-related concepts are classified based on drug-induced symptoms.

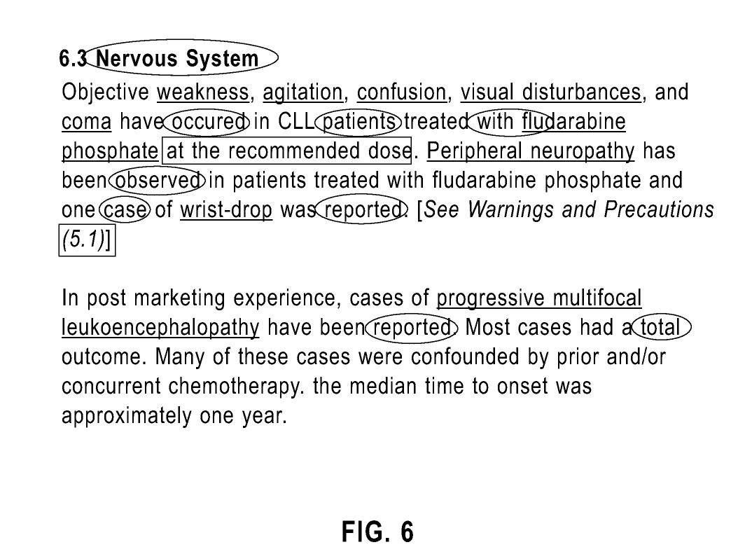

First, searching process along the first path will be described. In some particular examples, terms for adverse effects appear in subsections of SPL which correspond to particular body systems, for example, as shown in FIG. 6. FIG. 6 shows another example of a labeled content of a section. It can be seen from FIG. 6 that the labeled terms for adverse effects, such as coma, are present under the title of the subsection—“nervous system”, and therefore it can be determined that all the terms for adverse effects contained therein should be directed to the nervous system of a body. Thus, we can extract from SNOMED CT a series of disorder concepts directed to body systems, including Disorder of cardiovascular system (disorder), Disorder of digestive system (disorder), Disorder of immune structure (disorder), Disorder of musculoskeletal system (disorder), Disorder of nervous system (disorder). In this example, the term for adverse effects appears in “nervous system”, and therefore, search can be conducted, beginning from the concept “Disorder of nervous system (disorder)”, from top to bottom along the hierarchy in which the disorder concepts are classified based on body sites, so as to determine whether there is a concept matched with the term for adverse effects to be located (such as coma) among the nodes of the above mentioned hierarchy. If there are more than one matched concept, these concepts are retained for further analysis.

In other particular examples, terms for adverse effects do not appear in subsections corresponding to particular body systems, for example, as shown in FIG. 4. In the section shown in FIG. 4, it does not indicate the particular body system that the terms for adverse effects, such as nausea, are directed to, when there are plurality of concepts in SNOMED CT that match with “nausea”, as shown in FIG. 5. In this case, for each matched concept as shown in FIG. 5, retrospective searching can be conducted, beginning from this concept, from bottom to top along the hierarchy in which the disorder concepts are classified based on body sites, so as to determine whether it finally reaches a disorder concept directing to a body system. The matched concepts that can reach particular body systems are retained for further analysis.

During the process of searching along the first path as described above, it can also combine the searching from top to bottom with the searching from bottom to top in order to improve the efficiency of searching and enhance its performance.

After obtaining some candidate concepts via the first path, the process further locks on the final target concept via the second path. The second path is a path in which searching is conducted based on drug-induced symptoms in a disorder-related concepts hierarchy. In the hierarchy in which classification is based on drug-induced symptoms, the root node is “drug-related disorder”, and all drug-related disorders are the successor nodes of this root node.

As symptoms induced by adverse effects belong to drug-induced symptoms, therefore, terms for adverse effects should have corresponding concepts in the drug-induced symptoms hierarchy. Based on that, the common nodes shared by the first path and the second path are considered to be the concepts corresponding to terms for adverse effects. In order to find such common nodes, the process can analyze the candidate concepts obtained by searching along the first path, to determine whether the candidate concepts are present in the second path. In particular, in one example, beginning from the root node “drug-related disorder”, it traverses all paths along the drug-induced symptom hierarchy, to check whether the nodes involved in the paths belong to the candidate concepts.

Alternatively, in another example, for each candidate concept, it backtracks from bottom to top along the drug-induced symptom hierarchy, to check whether it can reach the root node “drug-related disorder”. Of the common concepts shared by the first path and the second path, the finest grained concept is considered to be the concept most appropriate for the term for adverse effects.

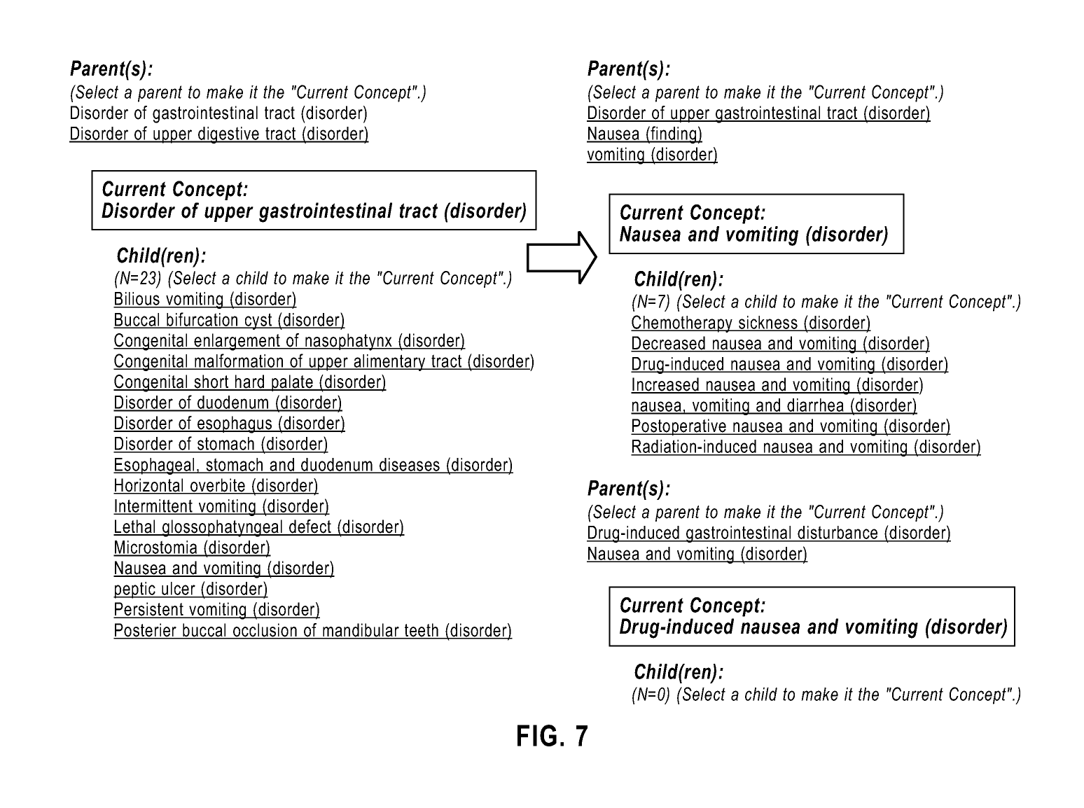

The matching process along two paths will be illustrated by taking the term for adverse effects “nausea” for example, as shown in FIG. 4 and FIG. 5. FIG. 7 shows the matching process of the term for adverse effects “nausea”. As shown in FIG. 7 (left column and the top side of right column), the searching along the first path obtains at least the following concepts as candidate concepts: Nausea and vomiting (disorder), Decreased nausea and vomiting (disorder), Drug-induced nausea and vomiting (disorder), Increased nausea and vomiting (disorder), Nausea, Vomiting and diarrhea (disorder), Postoperative nausea and vomiting (disorder), Radiation-induced nausea and vomiting (disorder), for starting from these concepts it can reach the generic concept “Disorder of upper gastrointestinal tract (disorder)”, and further a particular body system. Further screening along the second path selects the particular concept “Drug-induced nausea and vomiting (disorder)” as the concept corresponding to the term for adverse effects, as shown in FIG. 7 (the bottom side of right column).

More particularly, the path taken to search for the particular concept based on body sites in the disorder-related concept hierarchy, i.e. the first path, is, from top to bottom, Disorder by body site (disorder)->Disorder of body system (disorder)->Disorder of digestive system (disorder)->Disorder of digestive tract (disorder)->Disorder of gastrointestinal tract (disorder)->Disorder of upper gastrointestinal tract (disorder)->Nausea and vomiting (disorder)->Drug-induced nausea and vomiting (disorder). The path taken to search for the particular concept based on drug-induced symptoms in the disorder-related concept hierarchy, i.e. the second path, is, from top to bottom, Drug-related disorder (disorder)->Drug-induced gastrointestinal disturbance (disorder)->Drug-induced nausea and vomiting (disorder). Thus, we match a single term for adverse effects with a particular concept in SNOMED CT.

For compound words and phrases in terms for adverse effects, if we fail to locate a matched concept in the SNOMED CT system, we can split the compound words or phrases and perform the matching process described above to the split terms separately. For example, for the phrase “pulmonary toxity” which is a term for adverse effects, we fail to locate a concept matched with it in SNOMED CT system. Therefore, we can split the phrase into two parts, i.e. pulmonary and toxity. For each part, we perform the above mentioned matching process separately. Finally, “Pulmonary” is matched with the concept “poisoning (disorder)”, and “toxity” is matched with the concept “disorder of lung (disorder)”. Thus, the phrase can be matched with a set of concepts—poisoning (disorder) and disorder of lung (disorder).

By the process described above, the terms or phrases for adverse effects in the ADR/ADE information can be matched with particular concepts in SNOMED CT system respectively, so that the key information in the ADR/ADE information can be normalized into the SNOMED CT system.

Considering the characteristics of SNOMED CT system, we select two paths for locating terms for adverse effects, i.e. the path classified by body sites and the path classified by drug-induced symptoms, and consider the common nodes shared by the two paths as the most appropriate nodes.

For the SNOMED CT system, such two paths are the most convenient for locating an appropriate disorder-related concept. However, for other structured and normalized terminology system, there can be different classification for various terms and concepts, and therefore there can be different paths that are suitable to locate terms for adverse effects. Generally speaking, it needs two or more paths to accurately locate the terms, and the finally matched concepts are the common nodes shared by the two or more paths.

In some cases, the information of adverse effects also includes the precondition information of the adverse effects, as shown by the rectangles in FIG. 4 and FIG. 6. In one example, the precondition-related terminology, such as other drug names, is matched with particular concepts in the normalized terminology system as far as possible, and the description to the precondition is retained, in order to provide full description to the information of adverse drug effects.

By the process described above, the drug information and the information of adverse drug effects have been matched with particular concepts in the structured and normalized terminology system. Subsequently, we organize the obtained particular concepts, and establish the relationship between the concepts corresponding to the drug information and the concepts corresponding to the information of adverse drug effects, thereby obtaining complete information of adverse drug effects. Thus, all information relating to adverse drug effects extracted from the information source has been standardized and normalized. Since each concept in the structured and normalized terminology system has a unique code, such standardization and normalization convert the information of adverse drug effects extracted from various information sources, usually in text format, into definite concepts in code format. Such conversion is very advantageous to the collection, integration, search, calculation, propagation and further analysis of the information.

By standardizing and normalizing the information of adverse drug effects, doctors, patients, drug administrative institutes, and drug research and manufacture institutes can conveniently search, exchange and update the ADR/ADE-related information, therefore substantially avoiding unfortunate events associated with the adverse effects. In one example, the information of adverse effects provided by the above examples can be integrated into the existing Electronic Medicine Record (EMR) system. Since the EMR system has already employed similar, normalized terminology system to describe the medical history and drug-administration history of patients, and the information of adverse effects in the above examples is also provided in code format in the normalized terminology system, therefore, these two types of information can be easily integrated into each other. Thus, when a doctor prescribes, he/she can give suggestions that are more suitable for the individual conditions of a patient by referencing simultaneously the medical history and drug-administration history of the patient as well as the information of adverse drug effects. In another example, the information of adverse effects in standard code format is also very advantageous to help further treatment and analysis by computers.

For example, we suppose the following information of adverse effects is provided by the above examples: Drug A and Drug B have adverse interactions, and they have active ingredients A′ and B′ respectively. Given such information, the analyzing and treating system can infer that all the parent nodes of Drug A that comprises the ingredient A′ can probably have adverse reaction with Drug B. In addition, the information of adverse effects in code format is very advantageous to transmit across systems. The above mentioned advantages cannot be possessed by the information of adverse effects that is in general text format and is not standardized or normalized.

A method for providing the information of adverse drug effects according to the invention is described. Based on the same inventive concept, the present invention also relates to an apparatus for providing the information of adverse drug effects accordingly.

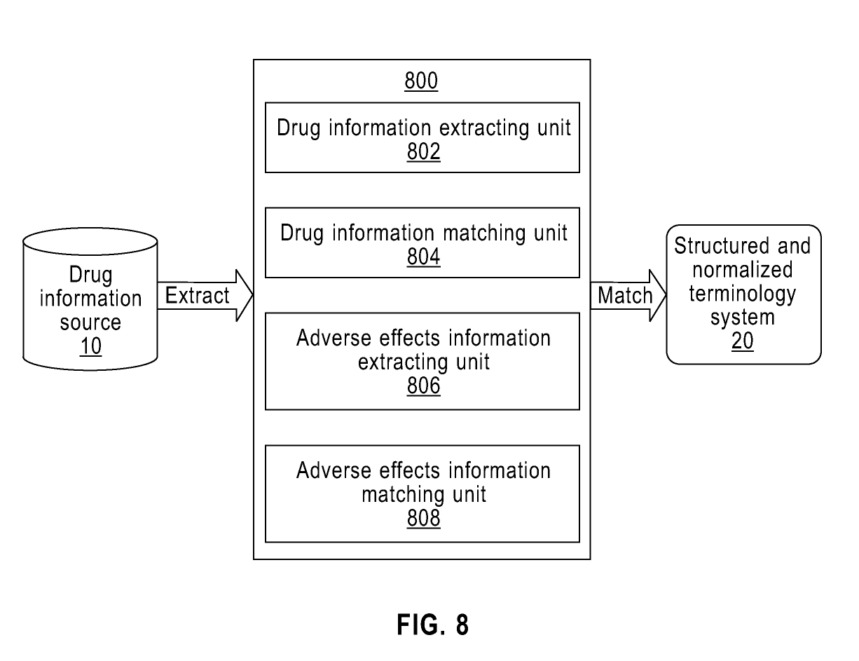

FIG. 8 shows an apparatus for providing the information of Adverse Drug Effects according to an example of the invention. As shown in FIG. 8, an apparatus 800 for providing the information of Adverse Drug Effects includes: a drug information extracting unit 802, configured to extract from a drug information source 10 at least first information and second information in the basic information of a drug; a drug information matching unit 804, configured to, according to the first information and the second information, match the drug with a particular drug-related concept in a structured and normalized terminology system 20; an adverse effects information extracting unit 806, configured to extract from the drug information source 10 the information of Adverse Drug Effects associated with the adverse effects of the drug; and an adverse effects information matching unit 808, configured to, in the structured and normalized terminology system 20, along different paths in at least two disorder-related classified hierarchies, match the information of Adverse Drug Effects with a particular disorder-related concept in the structured and normalized terminology system 20.

In an example, the drug information source 10 is SPL files, and the structured and normalized terminology system 20 is SNOMED CT system.

In the above mentioned apparatus for providing the information of Adverse Drug Effects, each unit is configured to perform a corresponding step of the method for providing the information of Adverse Drug Effects according to the present invention. Therefore, it is unnecessary to describe in detail the implementation and design of the apparatus.

Through the above description of the embodiments, those skilled in the art will recognize that the above-mentioned system and method for providing the information of Adverse Drug Effects can be practiced by executable instructions and/or controlling codes in the processors, e.g. codes in mediums like disc, CD or DVD-ROM; memories like ROM or EPROM; and carriers like optical or electronic signal carrier. The system, apparatus and its units in the embodiments can be realized using hardware like VLSI or Gates and Arrays, like semiconductors e.g. Logic Chip, transistors, etc., or like programmable hardware equipments e.g. FPGA, programmable logic equipments, etc.; or using software executed by different kinds of processors; or using the combination of said hardware and software

Although a method and apparatus of the present invention for providing the information of Adverse Drug Effects evaluating attention degree have been described in conjunction with detailed embodiments, the present invention is not limited thereto. Those skilled in the art can make various changes, substitutions and modifications in light of the teachings of the description without departing from the spirit and scope of the invention. It should be appreciated that, all such changes, substitutions and modifications still fall into protection scope of the invention which is defined by appended claims.

What is claimed is:

1. A method for providing information of adverse drug effects, the method comprising:
extracting at least a first information and a second information in basic information of a drug from a drug information source;
matching the drug with a particular drug-related concept in a structured and normalized terminology system according to the first and the second information;
extracting, from the drug information source, the information of Adverse Drug Effects associated with the drug; and
matching the information of Adverse Drug Effects with a particular disorder-related concept in the structured and normalized terminology system;
wherein the matching is along different paths in at least two disorder-related classified hierarchies.

2. The method according to claim 1, wherein the drug information source is SPL files and the structured and normalized terminology system is SNOMED CT system.

3. The method according to claim 1, wherein the first information and the second information cross with each other in two drug-related classified hierarchies.

4. The method according to claim 1, wherein the matching drug comprises:
using the first information to carry out preliminary matching, thus obtaining at least one drug-related candidate concept; and
using the second information to carry out further matching for the at least one candidate concept, thus obtaining the matched particular drug-related concept.

5. The method according to claim 4, wherein the step of using the first information to carry out preliminary matching comprises:
performing fuzzy search for the first information along the first classified hierarchy in the structured and normalized terminology system, thus obtaining at least one fuzzy matched candidate concept, wherein the first classified hierarchy is a hierarchy in which the drug-related concepts are classified based on the first information.

6. The method according to claim 5, wherein the step of performing search for the first information along the first classified hierarchy comprises:
searching for the first information from top to bottom along the first classified hierarchy.

7. The method according to claim 4, wherein the step of using the second information to carry out further matching for the at least one candidate concept comprises:
searching for parent nodes of the candidate concept along the second classified hierarchy in the structured and normalized terminology system, wherein the second classified hierarchy is a hierarchy in which the drug-related concepts are classified based on the second information;
judging whether the parent node matches with the second information; and
considering the drug-related candidate concept whose parent node matches with the second information as the selected concept.

8. The method according to claim 4, wherein the step of using the second information to carry out further matching for the at least one candidate concept comprises:
searching for the description relating to the second information in the structured and normalized terminology system for each candidate concept;
judging whether the description matches with the second information; and
considering the candidate concept whose description matches with the second information as the selected concept.

9. The method according to claim 7, further comprising:
judging whether the selected concept has child nodes; and
considering the selected concept having no child nodes as the particular drug-related concept.

10. The method according to claim 8, further comprising:
judging whether the selected concept has child nodes; and
considering the selected concept having no child nodes as the particular drug-related concept.

11. The method according to claim 1, wherein the step of extracting the information of Adverse Drug Effects comprises:
extracting terms for adverse effects.

12. The method according to claim 1, wherein the different paths in at least two disorder-related classified hierarchies comprise:
the first path in the hierarchy in which disorder-related concepts are classified based on body sites and the second path in the hierarchy in which disorder-related concepts are classified based on drug-induced symptoms.

13. The method according to claim 12, wherein the step of matching the information of Adverse Drug Effects with a particular disorder-related concept in the structured and normalized terminology system comprises:
searching for the common node shared by the first path and the second path and considering the concept corresponding to the common node as the particular disorder-related concept.

14. An apparatus for providing information of Adverse Drug Effects of a drug, the apparatus comprising:
a drug information extracting unit configured to extract at least a first information and a second information in basic information of a drug from a drug information source;
a drug information matching unit configured to match the drug with a particular drug-related concept in a structured and normalized terminology system according to the first and the second information;
an adverse effects information extracting unit, configured to extract from the drug information source the information of Adverse Drug Effects; and
an adverse effects information matching unit, configured to match the information of Adverse Drug Effects with a particular disorder-related concept in the structured and normalized terminology system, wherein the matching is along different paths in at least two disorder-related classified hierarchies.

15. The apparatus according to claim 14, wherein the drug information source is SPL files and the structured and normalized terminology system is SNOMED CT system.

16. The apparatus according to claim 14, wherein the first information and the second information cross with each other in two drug-related classified hierarchies.

17. The apparatus according to claim 14, wherein the drug information matching unit is further configured to:
use the first information to carry out preliminary matching, thus obtaining at least one candidate concept; and
use the second information to carry out further matching for the at least one candidate concept, thus obtaining the matched particular concept.

18. The apparatus according to claim 17, wherein the drug information matching unit is further configured to:
search for the first information along the first classified hierarchy, thus obtaining at least one fuzzy matched candidate concept;
wherein the first classified hierarchy is a hierarchy in which the drug-related concepts are classified based on the first information.

19. The apparatus according to claim 18, wherein the drug information matching unit is further configured to:
search for the first information from top to bottom along the first classified hierarchy.

20. The apparatus according to claim 17, wherein the drug information matching unit is further configured to:
search for parent nodes of the candidate concept along the second classified hierarchy, wherein the second classified hierarchy is a hierarchy in which the drug-related concepts are classified based on the second information;
judge whether the parent node matches with the second information; and
consider the candidate concept whose parent node matches with the second information as the selected concept.

21. The apparatus according to claim 17, wherein the drug information matching unit is further configured to:
search for the description relating to the second information for each candidate concept in the structured and normalized terminology system;
judge whether the description matches with the second information; and
consider the candidate concept whose description matches with the second information as the selected concept.

22. The apparatus according to claim 20, wherein the drug information matching unit is further configured to:
judge whether the selected concept has child nodes; and
consider the selected concept having no child nodes as the particular drug-related concept.

23. The apparatus according to claim 21, wherein the drug information matching unit is further configured to:
judge whether the selected concept has child nodes; and
consider the selected concept having no child nodes as the particular drug-related concept.

24. The apparatus according to claim 14, wherein the adverse effects information extracting unit is configured to:
extract terms for adverse effects.

25. The apparatus according to claim 14, wherein the different paths in at least two disorder-related classified hierarchies comprise:
the first path in the hierarchy in which disorder-related concepts are classified based on body sites; and
the second path in the hierarchy in which disorder-related concepts are classified based on drug-induced symptoms.

26. The apparatus according to claim 25, wherein the adverse effects information matching unit is configured to:
search for the common node shared by the first path and the second path; and
consider the concept corresponding to the common node as the particular disorder-related concept.
